(19) United States
(12) Patent Application Publication
(10) Pub. No.: US 2010/0090903 A1
(43) Pub. Date: Apr. 15, 2010

(54) OMNI-DIRECTIONAL PLANAR ANTENNA

(76) Inventors: Woo-Jin Byun, Daejon (KR); Bong-Su Kim, Daejon (KR); Kwang-Seon Kim, Daejon (KR); Myung-Sun Song, Daejon (KR)

Correspondence Address: LADAS & PARRY LLP, 224 SOUTH MICHIGAN AVENUE, SUITE 1600, CHICAGO, IL, 60604, US

(21) Appl. No.: 12/517,593

(22) PCT Filed: Nov. 29, 2007
(86) PCT No.: PCT/KR07/06101

§ 371 Date: Jun. 4, 2009

(30) Foreign Application Priority Data
Dec. 5, 2006 (KR) 10-2006-0122474

(51) Int. Cl. H01Q 1/38

(52) U.S. Cl. 343/700 MS

(57) ABSTRACT

Provided is a planar antenna having omni-directional radiation patterns. The planar antenna includes a circular patch located on one dielectric substrate of the plurality of dielectric substrates; a planar transmission line applied with signals from the exterior; a signal via for coupling the circular patch with the planar transmission line and supplying the signals incoming through the planar transmission line to the circular patch; and a metal ground plane having a slot having a certain shape through which the signal via passes, and located on the dielectric substrate.

### TECHNICAL FIELD

The present invention relates to a planar antenna having omni-directional radiation patterns, and, more particularly, to a planar antenna having omni-directional radiation patterns, which includes a parasitic circular patch having a laminated structure at a high frequency band and a circular-shape resonator spaced at a predetermined distance from the parasitic circular patch, thereby making the bandwidth thereof wider.

This work was supported by the IT R&D program for MIC/IITA. [2005-S-046-02, “Development of the basic spectrum resource utilizing technology”].

### BACKGROUND ART

Until now, in systems for wireless communications, an omni-directional antenna has been used. The omni-directional antenna includes a monopole antenna, a dipole antenna, a helical antenna and the likes, and is disadvantageous in that the occupied area thereof is large.

Meanwhile, in small and lightweight systems, such as cellular terminals, Wireless Local Area Networks (WLAN), or Wireless Personal Area Networks (WPAN), a planar antenna or a chip antenna which have omni-directional characteristics, have been used.

Since the planar antenna is advantageous in terms of price, a variety of structures have been proposed.

The planar antennas represent the following radiation patterns in an elevation direction and an azimuth direction. That is, the planar antenna does not radiate energy in the elevation direction (that is, a direction pointing toward a z axis direction of θ=0° and represents omni-directional radiation patterns in the azimuth direction (that is, a direction pointing toward an x-y plane direction of θ=90°.

The planar antenna has a modified structure from a linear antenna, such as a monopole or dipole antenna. The planar antenna is disadvantages in that the radiation patterns of a directional antenna in which energy is concentrated in a particular direction is represented rather than omni-directional radiation patterns at a high frequency band, such as a frequency band such as millimeter waves.

In order to overcome the disadvantages, it has been proposed that a planar antenna uses the diffraction characteristics of surface waves in the interfaces between ground planes.

The planar antenna has omni-directional radiation patterns in an azimuth plane regardless of the range of frequencies. However, the planar antenna has a narrow bandwidth of typically 5%, and the structure for feeding the antenna employ a coaxial probe, so that there is a disadvantage in that the occupied area thereof is increased.

### DISCLOSURE OF INVENTION

### Technical Problem

An embodiment of the present invention is directed to providing a planar antenna having omni-directional radiation patterns, which includes a parasitic circular patch having a laminated structure at a high frequency band and a circular-shape resonator spaced at a predetermined distance from the parasitic circular patch, thereby making the bandwidth thereof wider.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a planar antenna having omni-directional radiation patterns, where the planar antenna is formed by laminating a plurality of dielectric substrates, including: a circular patch located on one dielectric substrate of the plurality of dielectric substrates; a planar transmission line applied with signals from the exterior; a signal via for coupling the circular patch with the planar transmission line and supplying the signals incoming through the planar transmission line to the circular patch; and a metal ground plane having a slot having a certain shape through which the signal via passes, and located on the dielectric substrate.

Furthermore, the planar antenna in accordance with the present invention further includes a parasitic circular patch having an identical center to the circular patch and located on the dielectric substrate spaced apart at a predetermined distance.

Furthermore, the planar antenna in accordance with the present invention further includes one or more ring resonator located on the dielectric substrate and around the circular patch and the parasitic circular patch; and a plurality of ground vias for connecting the ring resonator and the metal ground plane.

### Advantageous Effects

As described above, the present invention has omni-directional radiation patterns at a high frequency band, thereby archiving minimization and low-price.

Furthermore, the present invention facilitates integration with an integrated circuit and can be easily implemented even in a silicon semiconductor element.

### BRIEF DESCRIPTION OF THE DRAWINGS

FIG. 1 illustrates a front side of the planar antenna having omni-directional radiation patterns in accordance with an embodiment of the present invention.

FIG. 2 illustrates the reverse view of the planar antenna having omni-directional radiation patterns in accordance with an embodiment of the present invention.

FIG. 3 is a cross-sectional view of FIG. 1 along line A-A′ in accordance with one embodiment of the present invention.

FIG. 4 is a sectional view of another embodiment for the planar antenna having omni-directional radiation patterns in accordance with another embodiment of the present invention.

FIG. 5 is an exemplary graph illustrating the input reflection characteristics of the planar antenna having omni-directional radiation patterns in accordance with an embodiment of the present invention.

FIGS. 6 and 7 are exemplary graphs illustrating the radiation pattern characteristics of the planar antenna having omni-directional radiation patterns in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

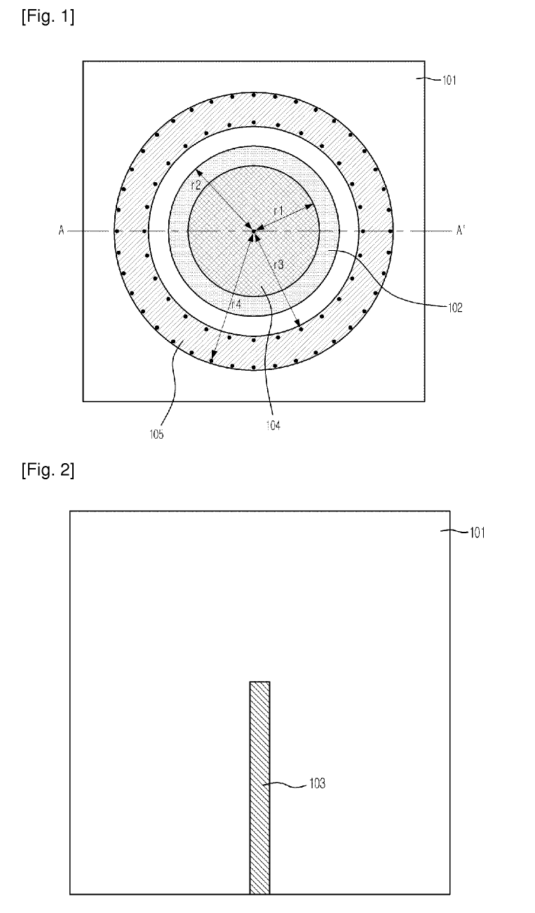

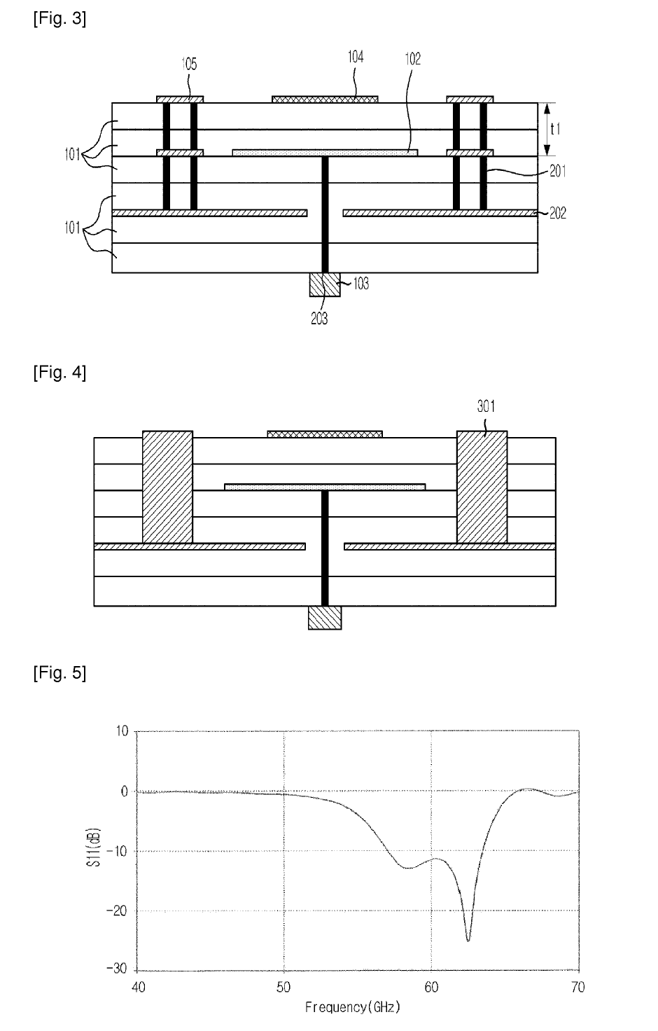

FIGS. 1 and 2 are plan views of a planar antenna having omni-directional radiation patterns, which is called a planar antenna hereinafter, in accordance with an embodiment of the present invention, and FIG. 3 is a cross-sectional view of FIG. 1 along line A-A′ in accordance with one embodiment of the present invention. In this case, FIG. 1 illustrates the front side of the planar antenna having omni-directional radiation patterns according to the present invention and FIG. 2 illustrates the reverse view of the planar antenna having omni-directional radiation patterns in accordance with the present invention.

Referring to FIGS. 1, 2 and 3, the planar antenna is an omni-directional antenna using the diffraction of surface waves which is fed with a planar transmission line, which is small and lightweight, using a multilayer substrate and a plurality of vias.

The planar antenna is formed by laminating dielectric substrates 101 having a predetermined thickness. Additionally, the dielectric substrate 101 is implemented using a semiconductor substrate, such as silicon (Si), a ceramic substrate, such as Low Temperature Co-fired Ceramics (LTCC) for high frequencies, a glass substrate, such as Liquid Crystal Polymer (LCP), or the like.

Furthermore, the planar antenna has a structure in which a plurality of metal patch having large electric conductivity is printed on the dielectric substrate, which is described below.

First, the planar antenna has a circular patch 102 which is one of metal patches printed on the dielectric substrate 101. The circular patch 102 represents an omni-directional radiation patterns, and has a radius of “r2.” In this case, the circular patch 102 is fed with the planar transmission line 103 illustrated in FIG. 2, and is coupled to the planar transmission line 103 through the signal vias 203 illustrated in FIG. 3. The above-described planar antenna employs feeding method using the planar transmission line 103 which can be implemented easily on the multilayer substrate not using feeding method having a larger area, such as a coaxial probe. Therefore, the planar antenna can obtain characteristics of omni-directional radiation patterns having a narrow bandwidth through the circular patch.

Furthermore, the planar transmission line 103 may be implemented using a microstrip transmission line, a strip transmission line, a Co-Planar Waveguide (CPW), a Grounded Co-Planar Waveguide (GCPW) or the like.

Furthermore, the planar antenna has a parasitic circular patch 104 which is another of metal patches printed on the dielectric substrate 101. The parasitic circular patch 104 is spaced apart at a certain distance of “t1” above the circular patch 102 as illustrated in FIG. 3 and has a radius of “r1.” In this case, the parasitic circular patch 104 has an identical center to the circular patch 102.

Since the parasitic circular patch 104 is spaced apart at a certain distance above the circular patch 102 in the planar antenna, the planar antenna is implemented as an antenna having characteristics of the omni-directional radiation patterns having a wide bandwidth rather than an antenna having characteristics of the omni-directional radiation patterns having a narrow bandwidth rather.

Meanwhile, in order to make the bandwidth wider, ring resonators 105 are arranged at locations of radiuses of “r3” and “r4” around the circular patch 102 fed with power and the parasitic circular patch 106 in the planar antenna. One or more ring resonators 105 may be arranged between the dielectric substrates 101.

In this case, the ring resonator 105 is connected to a metal ground plane 202 located there below through a plurality of ground vias 201. The metal ground plane 202 may be implemented with a structure which is entirely formed with metal, or which is partially formed with metal. Furthermore, slots having a certain shape are formed on the metal ground planes 202, thereby passing the signal vias 203 connecting the circular patch 102 with the planar transmission line 103 therethrough. The metal ground planes 202 employ the diffraction feature of surface waves at the interfaces between the ground planes in order to overcome the characteristics of directional antennas in which energy is concentrated in a particular direction in a high frequency band, such as millimeter waves. As a result, the planar antenna represents characteristics of omni-directional radiation patterns.

Therefore, although the circular patch 102 represents omni-directional radiation patterns, the planar antenna makes up for about 5% narrow bandwidth by including the parasitic circular patch 104 having a laminated structure and the ring resonator 105 at a certain distance from the parasitic circular patch 104, thereby presenting about 10% wide bandwidth while having omni-directional radiation patterns even at a high frequency band, such as millimeter waves.

Furthermore, the planar antenna employs the planar transmission line 103 which can be implemented easily on the multilayer substrate not using a feeding method having a larger area, such as a coaxial probe thereby facilitating an integrated circuit and integration. In particular, the planar antenna can be easily implemented in a semiconductor element, such as silicon.

FIG. 4 is a sectional view of another embodiment for the planar antenna having omni-directional radiation patterns in accordance with another embodiment of the present invention.

Referring to FIG. 4, it can be known that the planar antenna may be formed using a metal conductor 301 having a predetermined thickness instead of the plurality of ground vias 201.

FIG. 5 is an exemplary graph illustrating the input reflection characteristics of the planar antenna having omni-directional radiation patterns in accordance with an embodiment of the present invention.

Referring to FIG. 5, the input reflection characteristics of the planar antenna having omni-directional radiation patterns in accordance with the present invention represents a wide bandwidth of about 10% even at a high frequency band.

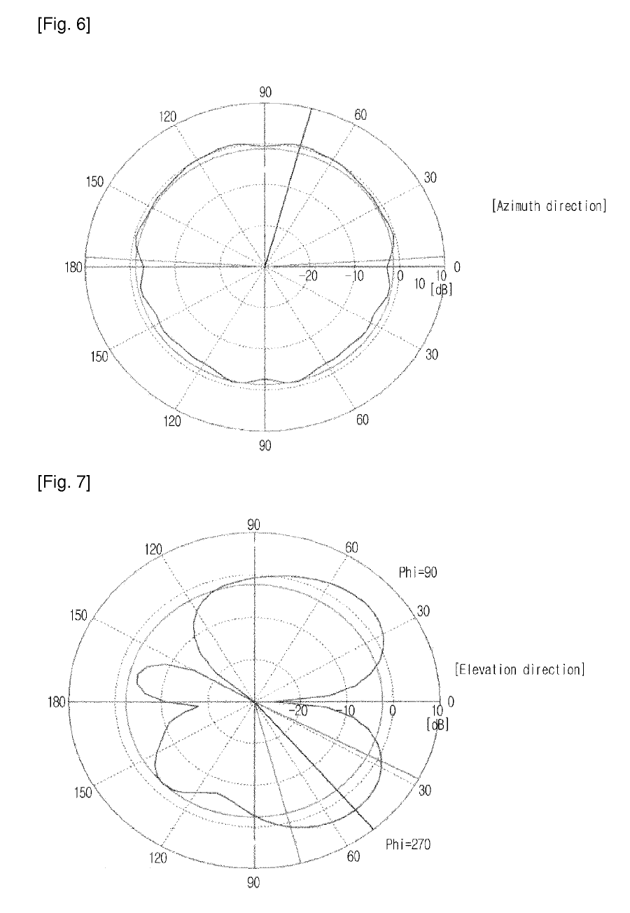

FIGS. 6 and 7 are exemplary graph illustrating the radiation pattern characteristics of the planar antenna having omni-directional radiation patterns in accordance with an embodiment of the present invention.

Referring to FIGS. 6 and 7, according to the radiation pattern characteristics of the planar antenna having omni-directional radiation patterns according to the present invention, omni-directional characteristics are represented in the azimuth direction of FIG. 6 and null points at which signals are weakly radiated are represented at the particular angle in the particular direction of FIG. 7. As a result, it can be known that the radiation pattern characteristics of the planar antenna according to the present invention are similar with the radiation pattern characteristics of a monopole or dipole antenna.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application No. 2006-0122474, filed in the Korean Intellectual Property Office on Dec. 5, 2006, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A planar antenna having omni-directional radiation patterns, where the planar antenna is formed by laminating a plurality of dielectric substrates, comprising:
a circular patch located on one dielectric substrate of the plurality of dielectric substrates;
a planar transmission line applied with signals from the exterior;
a signal via for connecting the circular patch with the planar transmission line and supplying the signals incoming through the planar transmission line to the circular patch; and
a metal ground plane having a slot having a certain shape through which the signal via passes, and located on the dielectric substrate.

2. The planar antenna of claim 1, further comprising:
a parasitic circular patch having an identical center to the circular patch and located on the dielectric substrate spaced apart at a predetermined distance.

3. The planar antenna of claim 2, further comprising:
one or more ring resonator located on the dielectric substrate and around the circular patch and the parasitic circular patch; and
a plurality of ground vias for connecting the ring resonator and the metal ground plane.

4. The planar antenna of claim 2, further comprising:
one or more ring resonator located on the dielectric substrate and around the circular patch and the parasitic circular patch; and
a metal conductor having a predetermined thickness in order to connect the ring resonator and the metal ground plane.

5. The planar antenna of claim 2, wherein a radius of the circular patch is larger than that of the parasitic circular patch.

6. The planar antenna of claim 3, wherein the ring resonator is formed in a ring shape with two rings having radiuses larger than radiuses of the circular patch and the parasitic circular patch.

7. The planar antenna of claim 1, wherein the planar transmission line is one of a micro-strip transmission line, a strip transmission line, a Co-Planar Waveguide (CPW), and a Grounded Co-Planar Waveguide (GCPW).

8. The planar antenna of claim 1, wherein the metal ground plane is implemented with a structure which is entirely formed with metal.

9. The planar antenna of claim 1, wherein the metal ground plane is implemented with a structure which is partially formed with metal.
